(19) United States
(12) Patent Application Publication
(10) Pub. No.: US 2018/0291880 A1
(43) Pub. Date: Oct. 11, 2018

(54) METHOD AND SYSTEM FOR RECYCLING WELLS FOR ENERGY PRODUCTION IN A GEOTHERMAL ENVIRONMENT

(71) Applicants: PAUL CAIRNS, CALGARY (CA); JEFF SMITH, CLIVE (CA)

(72) Inventors: PAUL CAIRNS, CALGARY (CA); JEFF SMITH, CLIVE (CA)

(73) Assignee: ALBERTA GEOTHERMAL CORPORATION, Devon (CA)

(21) Appl. No.: 15/935,016

(22) Filed: Mar. 25, 2018

Related U.S. Application Data
(60) Provisional application No. 62/483,340, filed on Apr. 8, 2017.

(51) Int. Cl. F03G 7/04; F24T 10/13; F24T 10/30; F24T 50/00

(52) U.S. Cl. CPC F03G 7/04; F24T 10/13; F24T 2010/56; F24T 50/00; F24T 10/30

(57) ABSTRACT

A method and apparatus for recycling unused or suspended wells and areas with predetermined suitability for well installation. In one embodiment, existing unused well sites are repurposed for contact in or adjacent a geothermal zone. Drilling extends horizontally in direct contact with the geothermal zone for heat transfer and subsequently terminates at a newly drilled well. The heated working liquid within the sealed annulus is cooled within a sealed top loop at or below the surface and recirculated for further heat transfer. The closed loop is continuous above and below the geothermal formation and can cluster several such arrangements and also consolidate clusters in a drilling field of unused wells. The loop may be incorporated in areas with predetermined suitability (greenfield) for well installation.

### FIELD OF THE INVENTION

The present invention relates to a method and apparatus for reuse of unused drilled wells and areas predetermined for well installation which optionally include wells and/or well bores to capture geothermal heat energy within a formation of the area.

### BACKGROUND OF THE INVENTION

It is widely known that there tens of thousands of unused wells and well sites, particularly in Alberta. These having been disparagingly referred to as “garbage” and “litter”. They are unused for reasons such as being uneconomically feasible, having run dry amongst other reasons. There is reluctance among owners to abandon the well sites in view of the significant capital investment to effect abandonment. Accordingly, owners simply attempt to placate the disdain by stating that the unused wells could be used in the future and thus abandonment would be premature.

The situation has become a financial juggernaut considering that it is estimated that greater than 80,000 wells are currently unused in Alberta.

It has been reported that:

“The number of oil and gas wells abandoned by industry has expanded dramatically as depressed commodity prices forced operators into bankruptcy.
Alberta's inventory of wells without an owner financially capable of cleaning them up expanded greatly over the last 2 years to 2,500+, a clear indicator of the turmoil that rattled Alberta during the recession.
The surge means taxpayers will be on the hook to pay landowners annual rents to compensate them for use of their properties until the sites are returned to a natural state.
And property owners are seeking compensation in record numbers.
“We're just dealing with the tip of the iceberg,” said Daryl Bennett, director of the Alberta Surface Rights Federation, adding the tally of abandoned wells doesn't include licences involved in bankruptcy proceedings or those still being processed by the energy regulator.” [Reid Southwick, Calgary Herald, Dec. 28, 2016]

In the realm of the prior art, proposals have been promulgated to assuage the issue. Geothermal energy has been considered and systems are being tested to assess the feasibility of exploiting the geothermal gradient. It has been discussed to use a series of tubes to be inserted in the ground for water within the tubes to absorb the heat and recirculate it to the surface and subsequently into a recovery device for use of the heat.

The geothermal gradient is generally defined as the rate of temperature increase relative to increasing depth in the interior of the Earth. Quantitatively, this represents approximately 25° C. to 35° C. for each kilometer. As such, this amount of energy is too substantive too leave unused. The union of this energy with the unused wells has resulted in renewed interest with the unused wells as evinced in the prior art.

Roussy, in U.S. Pat. No. 8,132,631, issued Mar. 13, 2012, teaches a geothermal loop installation where a sonic drill is provided for rotating and vibrating a drill string into the ground. Fluid is provided within the interior volume of the string.

A geothermal transfer loop is positioned within the interior volume of the drill string and the drill string is removed from the ground.

Although useful in certain scenarios, the limitation with this arrangement relates to the confined interior volume of the drill string and further only a small area of the loop is exposed to a geothermal zone. This inherently limits efficient heat transfer.

U.S. Pat. No. 8,375,716, issued Feb. 19, 2013, to Ramaswamy et al. discloses an electrical generating power method and apparatus for sub-sea purposes and incorporates an organic Rankin cycle positioned within a pressure vessel. This forms a series of connected vessels positioned adjacent, on or in the sea floor. Fluid is circulated through the vessels in order to generate mechanical shaft power which is subsequently converted to electrical power.

The interconnection of wells is recognized by Henderson, in U.S. Pat. No. 3,941,422, issued Mar. 2, 1976. In the teachings, two wells are drilled into the salt bed, with one being essentially vertically arranged and the drilled distally from the first well and deflected towards the first well in such a manner that the bottom of the deflected well approaches within a selected distance of the bottom of the first well. Subsequently, the salt is fractured by the use of the liquid fracturing technique in one or the other or both of the two wells, to enable fluid flow between the two wells. The salt is mined by fresh water injection with recovery of saturated salt solution from the other well.

It is clear that Henderson teaches paired wells generally connected, but the teachings do not contemplate an energy recovery or heat exchange system driven by geothermal energy.

WellStar Energy, in a press release dated Dec. 1, 2016 briefly touches on the possibility of incorporating unused wells with a geothermal loop for energy recovery, however no specific details are mentioned in this regard or for interconnection of wells for thermal management.

Chevron, in an undated video disclosure, taught gas well interconnection at the Congo River Canyon Crossing Pipeline Project. An interconnecting pipeline was run from one side of the river to the other for supplying gas. Again, this was a specific use for well interconnection. Well recycle and interconnection in a geothermal loop was not discussed.

GreenFire Energy, in an article dated 2017, discuss a looped geothermal energy recovery system. Rather than using preexisting gas/oil wells for repurposing, new wells are drilled. This does nothing to control improperly maintained unused wells and in fact may contribute to new problems. The disclosure is silent on techniques used to effect the loop and further does not contemplate clustering and consolidation necessary for maximum efficiency.

It would be most desirable to have a methodology and apparatus that unified the energetically favorable geothermal gradient with the reuse/recycling of preexisting unused wells for generating power while also significantly reducing the deleterious consequences of improperly maintained suspended well. Further, it would be beneficial to reuse areas with predetermined suitability for well installation which optionally include wells for geothermal energy recovery.

The present invention uniquely correlates the thermodynamic parameters requisite to efficiently recover geothermal energy, mitigate poorly maintained wells and produce power with no greenhouse gas emissions.

### SUMMARY OF THE INVENTION

One object of one embodiment of the present invention is to provide an improved method and apparatus suitable for reuse of areas predetermined for well installation which optionally include wells or well bores for capturing geothermal energy within a formation of the area.

Another object of one embodiment of the present invention is to provide a method and apparatus for improving the efficiency and economics of unused wells or well sites.

A further object of one embodiment of the present invention is to provide a method for geothermal energy recovery, comprising:

providing an area with predetermined suitability for well installation;
providing a first new well and a second new well adjacent said first well;
connecting, in a closed loop fluid connection, each said first new well and said second new well at least a section of each said loop being in contact with a geothermal zone;
circulating a working fluid into said closed loop to recover energy from said geothermal zone; and
recovering thermal energy from said working fluid.

With the predetermined suitability, i.e. zoning, permitting, etc. in place for a selected area, more commonly referred to as a “greenfield”, such areas can be repurposed and become attractive for geothermal energy recovery, since the logistical requirements have been met. Further, this repurposing facilitates opportunities for industrial users to facilitate “behind the fence” power generation. The benefits of such a situation are immediately comprehensible.

A further object of one embodiment of the present invention is to provide a method of converting preexisting unused wells in spaced relation in a formation to capture heat energy, comprising:

providing an preexisting unused well;
forming a new well proximate said preexisting unused well;
linking said preexisting unused well and said new well in a continuous loop in a geothermal zone and a second zone spaced from said geothermal zone; and
circulating working liquid through said loop to capture heat from said geothermal zone.

In this scenario, there is a blending of so called “brownfield” technology with the “greenfield” technology in order to reuse existing sites and still realize the geothermal benefits.

As a still further object of one embodiment of the present invention, there is provided a geothermal energy recovery method, comprising:
providing a first new well and a second new well adjacent the first well;
connecting, in a closed loop fluid connection, each first new well and second new well at least a section of each said loop being in contact with a geothermal zone;
circulating a working fluid into said closed loop to recover energy from said geothermal zone;
recovering thermal energy from the working fluid; and
at least one of storing recovered thermal energy, generating power from the recovered thermal energy and heating a structure with the recovered thermal energy.

The latter object demonstrates the flexibility of the methodology. The geothermal energy may be used to heat domiciles, factories, learning institutions among a host of others while at the same time providing power to such structures. This is achieved with the closed loop technology herein which obviates pollution issues inherent with other energy sources to meet increasingly demanding controls for the environment.

In respect of immediate advantages attributable to the technology herein, the following are apparent:

A) The technology provides a viable alternative for energy production once fossil fuel burning is phased out:

B) The technology obviates the economic drawbacks associated with solar and wind energy production:

C) By incorporating existing wells and well sites which may be dilapidated, leaking or otherwise rendered hazardous, these wells and well sites will be modified and structurally improved when used in practicing the method;

D) Retrofitting is an economically robust use of the unused wells and well sites in view of the prohibitive costs inherent in repair, closure or abandonment:

E) The geothermal driver for the method is continuously available 24 hours regardless of wind speed or overcast weather;

F) The geothermal gradient is substantially uniform throughout vast areas and thus facilitates maximum flexibility in topographical layout of the well network in any given area;

G) The steam separator and super heater system can accommodate steam delivery upsets, where large amounts of carry over may occur over a short time period;

H) Satellite configurations are possible of consolidated wells in order to allow use of the greatest number of wells in a given area;

I) The technology completely avoids any calculated environmental transgressions; a casing is simply used to connect wells, with the casing carrying water between wells and a power production unit.

This enumeration of advantages is illustrative as opposed to exhaustive.

Having thus generally described the invention, reference will now be made to the accompanying drawings.

### BRIEF DESCRIPTION OF THE DRAWINGS

FIG. 1 is a schematic illustration of an array of unused wells;

FIG. 2 is a view similar to FIG. 1 illustrating the positioning of new wells disposed within the unused wells;

FIG. 3 is a first schematic representation of one embodiment of the present invention where new wells are clustered with unused wells;

FIG. 4 is a schematic representation invention where the clusters are consolidated;

FIG. 5 is a partial sectional detailed view of an unused well with a new well and the interconnection there between;

FIG. 5A is an enlarged section of the connection between the extension of an unused well and casing;

FIG. 6 is a view similar to FIG. 5 illustrating the closed loop in a surface to surface arrangement;

FIG. 7 is a schematic illustration of a further embodiment of the present invention; and

FIG. 8 is a schematic illustration of another embodiment of the present invention.

Similar numerals used in the Figures denote similar elements.

### DETAILED DESCRIPTION OF THE PREFERRED EMBODIMENTS

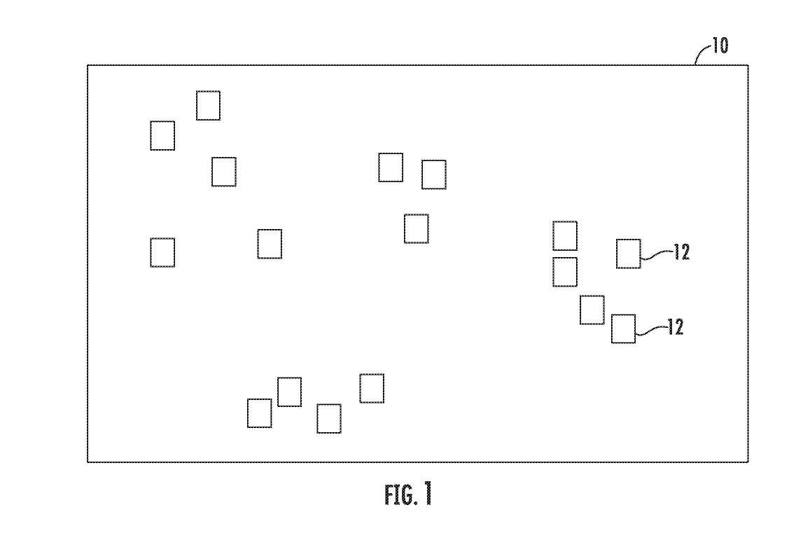

Referring now to FIG. 1, shown is a schematic illustration of a drilled area generally denoted by numeral 10 with a plurality of dispersed unused wells 12.

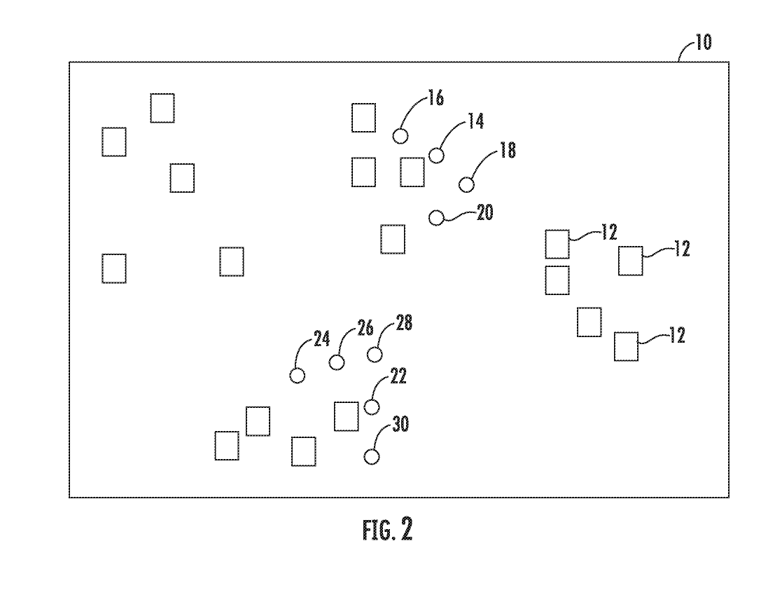

Referring now to FIG. 2, shown is a similar illustration to FIG. 1, however a plurality of new wells 16 through 30 have been drilled proximate a respective unused well 12.

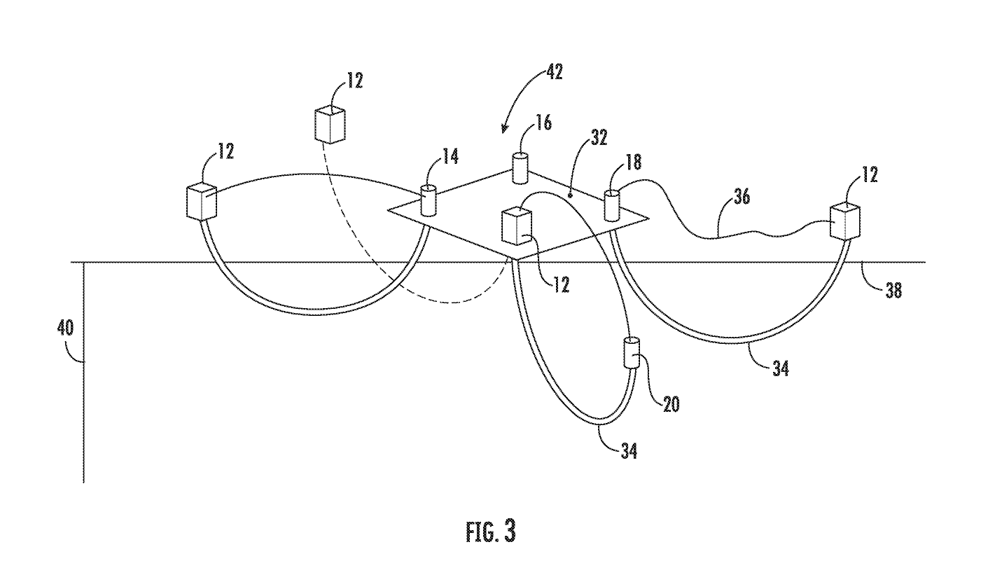

Turning to FIG. 3, a main hub 32 is provided. Although not specifically shown, hub 32 is effectively a manifold arrangement where each of the new wells 14, 16, 18 and 20 are in fluid communication discussed in greater detail herein after. From the hub 32, each of the new wells 14, 16 and 18 are spaced from each other and unused well 12 associated with the hub 32. Each new well 14, 16 and 18 is in fluid communication with a single proximate unused well 12. Fluid communication is achieved by piping 34 and 36. Piping 34 is disposed below the surface 38 and more specifically within a geothermal zone, generally denoted by numeral 40. As is illustrated, piping 34 is disposed above the surface 38 in the example, however it may be disposed below surface 38 which will be shown in the advancing Figures.

Conveniently, hub 32 with the new wells 14,16, 18 in the example as connected to a respective unused well 12 form clusters of recycled unused wells.

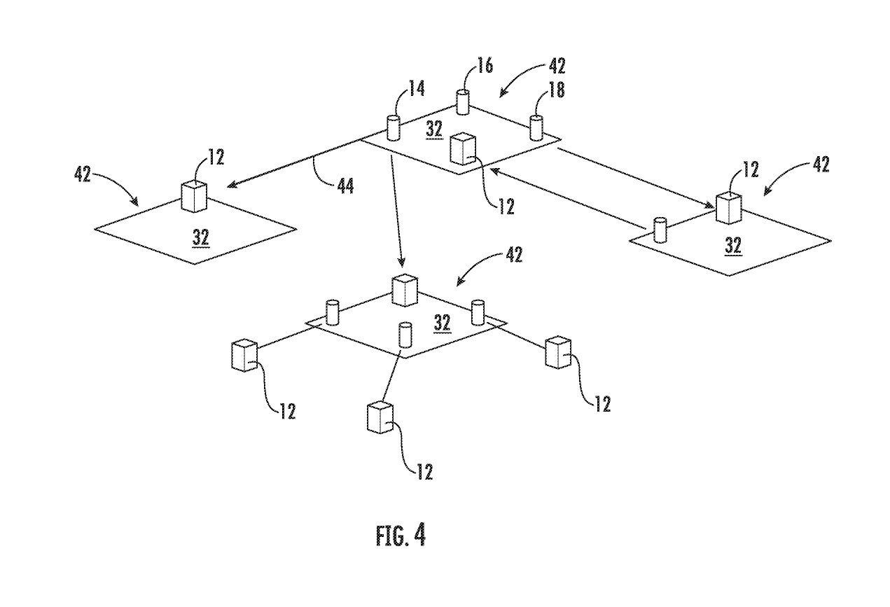

For clarity, FIGS. 3 and 4 can be referenced together and the loops 34 and 36 are absent in FIG. 4 for purposes of clarity. A cluster can be referenced in FIG. 3 denoted by numeral 42. The clustering is effective for linking additional clusters 42 as shown in FIG. 4. The new wells 14, 16 and 18 associated with a given hub 32 link other clusters 42 by way of an unused well 12 from an adjacent cluster 42. Such a link is referenced as 44 for purposes of explanation. In this manner, the clusters 42 are consolidated as an energy collecting system as opposed to a random unproductive array of unused wells 12 shown in FIG. 2. This provides a high efficiency arrangement for collecting geothermal energy in a closed loop surface to surface design.

Geothermal loops have been proposed ostensibly in the prior art discussed supra, however, in mosaic, the prior art has not provided adequate guidance in terms of the surface to surface energy recovery, minimal geological invasiveness unified with consolidated recycling.

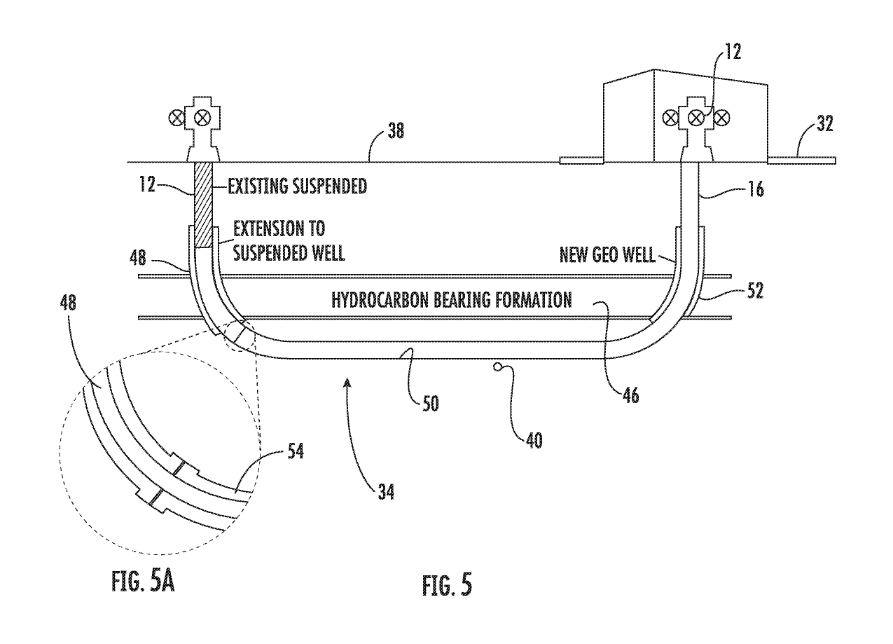

Turning now to FIG. 5, shown is a side view of a simplified unused well 12 connected to a hub 32. Existing well 12, owing to the fact that it was initially purposed to operate within hydrocarbon bearing formation 46, must be extended in depth to the geothermal zone 40. This may be achieved by drilling and adding an extension 48 for communication with a horizontal casing section 50. Casing 50 extends to new well 16, for example, via a second extension 52. The connection terminates at the hub 32 which is in fluid communication a manifold (not shown) associated with unused well 12.

FIG. 5A is an enlarged view of the connection between the extension 48 and a section 54 of the casing 50. This facilitates the connection between the unused well 12 and new well 16 in a surface to surface manner.

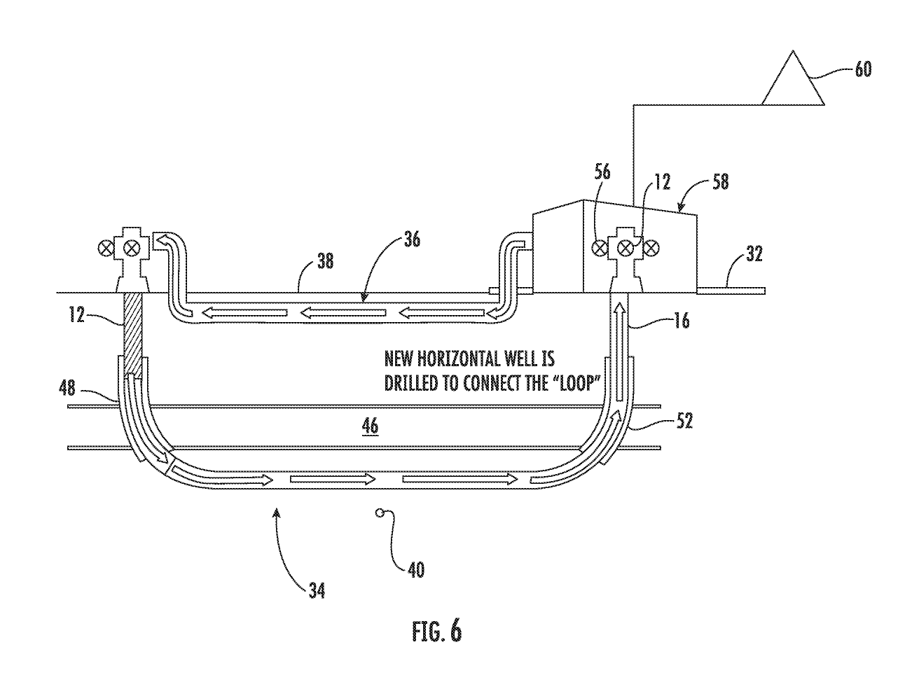

FIG. 6 schematically illustrates a complete loop arrangement, similar to FIG. 2 with parts removed for clarity. As shown, loop 36 completes the surface 40 to surface 38 energy loop. In this embodiment, loop 36 is shown in a subterranean disposition in spaced relation to loop 34, however it will be realized by those skilled that the same may be above the surface depending on the specific requirements of the situation.

For efficiency, the horizontal casing 50 will not be fixedly secured within the geothermal zone 40, but rather be in direct contact therewith. This facilitates most efficient heat exchange from the zone 40.

In terms of a working liquid for circulation within the arrangement, suitable choices will be apparent to those skilled.

Similarly, residence time the loops will be dictated by casing length, material among other factors all of which can be determined by known thermodynamic equations.

In order to use the energy captured by the system, connection to a power converter device, globally denoted by numeral 58 may be incorporated and optionally connected to a power grid 60 depending on proximity considerations.

In view of the fact that the existing well 12 is deepened, includes an extension 48 and any required fixative, the well 12 is effectively structurally restored. As is known from the discussion herein, such wells are often in poor condition, leaking, etc. The instant technology is clearly beneficial in this regard.

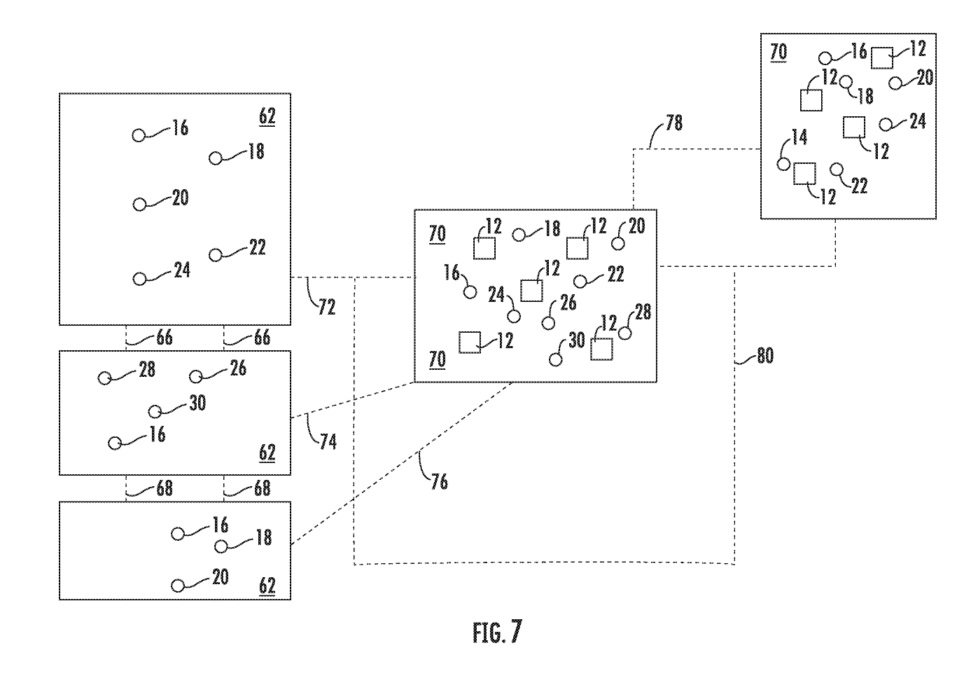

Turning to FIG. 7, shown schematically are a variety of implementations of the technology. Areas 62 are representative areas which have been predetermined as suitable and permissible for well installation. In this regard, the regulatory issues, permits, licenses, etc. have been addressed and the areas are what is referred to as “greenfield” areas. New wells, using the numbering convention from FIG. 2 are referenced as 16 through 30. The arrangement and interconnection is the same as that which has been discussed in reference to FIGS. 3 through 7.

Areas 64 may be present in a plurality and may be connected at 66 and 68 in a manner similar to that shown in FIGS. 3 and 4.

Area 70 is the same as FIG. 2 and is referred to a “brownfield” area which is a mix of existing wells 12 and new wells 16 through 30. Areas 62 and 70 may be interconnected singly at 72 or in a plurality at 74 and 76.

As referenced previously, the brownfield areas 70 may be connected as in FIG. 4 at 78.

Further, at least one of areas 72, 74, 76 may be interconnected with at least one of areas 70 at 80.

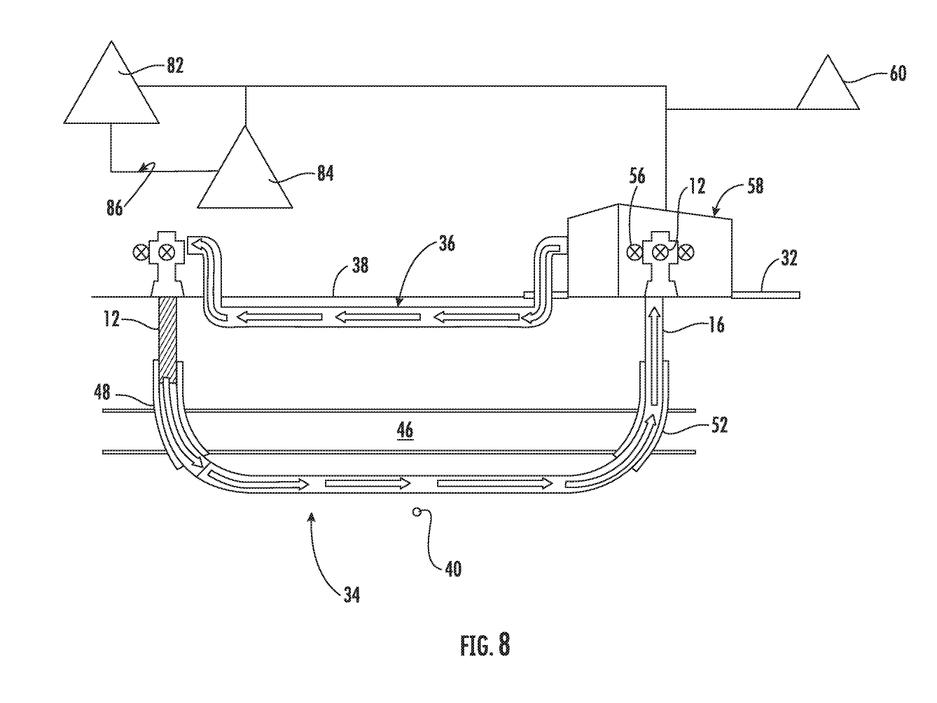

FIG. 8 illustrates the use of the recovered heat energy to be used not only for the power grid 60, but further for storage of the energy at 82 with suitable storage means known to those skilled. Further still, the energy may be used to heat a structure 84. This is particularly appealing for residential heat, but is envisioned for any structure. In this arrangement, the storage area 82 may be linked at 86 for energy supply to the structure 84.

By these additional embodiments, greenfield areas which are left unused can be reused/recycled using the geothermal loop technology embodiments established herein.

We claim:

1. A method for geothermal energy recovery, comprising:
providing an area with predetermined suitability for well installation;
providing a first new well and a second new well adjacent said first well;
connecting, in a closed loop fluid connection, each said first new well and said second new well at least a section of each said loop being in contact with a geothermal zone;
circulating a working fluid into said closed loop to recover energy from said geothermal zone; and
recovering thermal energy from said working fluid.

2. The method as set forth in claim 1, wherein said area is a greenfield.

3. The method as set forth in claim 1, wherein said area includes preexisting wellbores.

4. The method as set forth in claim 1, wherein said area includes preexisting wells.

5. The method as set forth in claim 1, wherein said area comprises a plurality of areas.

6. The method as set forth in claim 5, wherein said areas each include at least one of said first new well and said second new well.

7. The method as set forth in claim 6, wherein at least one area of said areas includes an unused well.

8. The method as set forth in claim 5, wherein at least one of said plurality of areas is suitable for behind the fence power generation.

9. The method as set forth in claim 1, further including the step of using recovered thermal energy for power generation.

10. The method as set forth in claim 1, further including the step of storing recovered thermal energy.

11. The method as set forth in claim 1, further including the step of using recovered thermal energy for heating purposes.

12. The method as set forth in claim 11, wherein said purposes include heating a building.

13. The method as set forth in claim 9, further including the step of using recovered thermal energy for power generation and heating purposes.

14. A method of converting preexisting unused wells in spaced relation in a formation to capture heat energy, comprising:
providing an preexisting unused well;
forming a new well proximate said preexisting unused well;
linking said preexisting unused well and said new well in a continuous loop in a geothermal zone and a second zone spaced from said geothermal zone; and
circulating working liquid through said loop to capture heat from said geothermal zone.

15. The method as set forth in claim 14, further including the step of recovering heated liquid for use in power generation.

16. The method as set forth in claim 14, further including the step of providing a plurality of additional wells proximate said unused well and said new well.

17. The method as set forth in claim 16, wherein said additional wells comprise newly drilled wells.

18. The method as set forth in claim 17, further including the step of forming a cluster said newly drilled wells with said new well adjacent said preexisting unused wells.

19. The method as set forth in claim 18, wherein said cluster connects each newly drilled well with said new well.

20. The method as set forth in claim 18, wherein a continuous loop is formed with each newly drilled well and new well.

21. The method as set forth in claim 10, wherein each said loop is positioned within a geothermal zone and a second zone spaced from said geothermal zone.

22. The method as set forth in claim 14, wherein said preexisting unused well is vertically extended to reach said geothermal zone.

23. The method as set forth in claim 14, further including extending said loop to reach said preexisting unused well for linkage.

24. The method as set forth in claim 14, further including the step of connecting an area with predetermined suitability for well installation which is absent wells.

25. The method as set forth in claim 14, further including the step of connecting a plurality of areas with predetermined suitability for well installation which is absent wells.

26. The method as set forth in claim 14, further including the step of storing heated working fluid.

27. The method as set forth in claim 1, further including the step of using heated working fluid for heating purposes.

28. The method as set forth in claim 27, wherein said purposes include heating a building.

29. The method as set forth in claim 9, further including the step of using recovered thermal energy for power generation and heating purposes.

30. A geothermal energy recovery method, comprising:
providing a first new well and a second new well adjacent said first well;
connecting, in a closed loop fluid connection, each said first new well and said second new well at least a section of each said loop being in contact with a geothermal zone;
circulating a working fluid into said closed loop to recover energy from said geothermal zone;
recovering thermal energy from said working fluid; and
at least one of storing recovered thermal energy, generating power from said recovered thermal energy and heating a structure with said recovered thermal energy.
